(19) United States
(12) Patent Application Publication
(10) Pub. No.: US 2022/0112326 A1
(43) Pub. Date: Apr. 14, 2022

(54) RENEWABLE-BASED FLEXIBLE POLYURETHANE FOAMS

(71) Applicant: Ford Global Technologies, LLC, Dearborn, MI (US)

(72) Inventors: Alper Kiziltas, Sarikamis (TR); Deborah Frances Mielewski, Ann Arbor, MI (US)

(73) Assignee: Ford Global Technologies, LLC, Dearborn, MI (US)

(21) Appl. No.: 17/068,752

(22) Filed: Oct. 12, 2020

(51) Int. Cl. C08G 18/32; C08G 18/76; C08G 18/18; C08G 18/08; C08J 9/12

(52) U.S. Cl. CPC C08G 18/3206; C08G 18/7685; C08G 2101/0083; C08G 18/14; C08J 9/125; C08G 18/18

(57) ABSTRACT

A polyurethane foam is produced by reacting a polyol-containing composition and an isocyanate composition. The polyol-containing composition includes a petrol-based polyol, an algae-based polyol, and a soy-based polyol.

### FIELD

The present disclosure relates to sustainable polyurethane foams.

### BACKGROUND

The statements in this section merely provide background information related to the present disclosure and may not constitute prior art.

Conventional methods for developing polyurethane foams typically include reacting a mixture with at least one polyol with hydroxyl groups (such as petroleum-based polyols) with a mixture having at least one isocyanate and/or diisocyanates in the presence of additives, such as blowing agents, surfactants, and catalysts by forming a gas (e.g., carbon dioxide) while urethane polymerization occurs (the mixture of the polyol mixture, the isocyanate mixture, and additives is also referred to as a reaction mixture). The gas is formed as a result of the blowing agent, which typically is water, reacting with the isocyanates, thereby forming carbon dioxide and polyurea.

Such polyurethane foams are used in a variety of automotive applications, as they can form lightweight, flexible, high-resilience, and rigid foams. It has been observed that bio-based (such as soy-based) polyols can be substituted for a small amount of the petroleum-based polyol, e.g., in an amount of up to about 12 parts by weight percent depending on the application, but greater concentrations of bio-based polyols greatly decrease mechanical and physical properties.

These issues related to the design of renewable-based polyurethane foams, particularly in automotive applications, are addressed by the present disclosure.

### SUMMARY

This section provides a general summary of the disclosure and is not a comprehensive disclosure of its full scope or all of its features.

In one form of the present disclosure, a polyurethane foam is produced by reacting a polyol-containing composition and an isocyanate composition. The polyol-containing composition includes an algae-based polyol at less than or equal to about 20 parts by weight percent, a petrol-based polyol at greater than or equal to about 70 parts by weight percent to less than or equal to about 90 parts by weight percent, and a balance of a soy-based polyol. Variations of the present disclosure are set forth below, which may be implemented individually or in any combination.

In a variation, the polyurethane foam further includes at least one of a cell opener, a surfactant, a cross-linking agent, a catalyst, and a water blowing agent. In a further variation, the cell opener is at about 1 parts by weight percent; the surfactant is at about 0.5 parts by weight percent; the cross-linking agent is at about 1.5 parts by weight percent; the catalyst includes a first catalyst at about 0.6 parts by weight percent and a second catalyst at about 0.3 parts by weight percent; and the water blowing agent is at about 3 parts by weight percent.

In another variation, the polyurethane foam has a compression set of less than or equal to about 50%.

In a further variation, the polyurethane foam has a tensile strength of greater than or equal to about 100 kPa.

In a further still variation, the polyurethane foam has a tear resistance of greater than or equal to about 450 N/m.

In a yet further variation, a vehicle component is formed of the polyurethane foam.

In another form of the present disclosure, a polyurethane foam is produced by reacting a polyol-containing composition and an isocyanate composition. The polyol-containing composition includes a soy-based polyol at less than or equal to about 20 parts by weight percent, a petrol-based polyol at greater than or equal to about 70 parts by weight to less than or equal to about 90 parts by weight percent, and a balance of an algae-based polyol.

In another variation, the polyurethane foam further includes at least one of a cell opener, a surfactant, a cross-linking agent, a catalyst, and a water blowing agent. In a further variation, the cell opener is at about 1 parts by weight percent; the surfactant is at about 0.5 parts by weight percent; the cross-linking agent is at about 1.5 parts by weight percent; the catalyst includes a first catalyst at about 0.6 parts by weight percent and a second catalyst at about 0.3 parts by weight percent; and the water blowing agent is at about 3 parts by weight percent.

In another variation, the polyurethane foam has a compression set of less than or equal to about 50%.

In a further variation, the polyurethane foam has a tensile strength of greater than or equal to about 100 kPa.

In a further still variation, the polyurethane foam has a tear resistance of greater than or equal to about 450 N/m.

In a yet further variation, a vehicle component is formed of the polyurethane foam.

In a still further form, a polyurethane foam is produced by reacting a polyol-containing composition and an isocyanate composition. The polyol-containing composition includes a bio-based polyol consisting essentially of a combination of a soy-based polyol and an algae-based polyol at less than or equal to about 80 parts by weight percent and a balance of a petrol-based polyol.

In a variation, the bio-based polyol is at less than or equal to about 80 parts by weight percent.

In another variation, the polyurethane foam further includes at least one of a cell opener, a surfactant, a cross-linking agent, a catalyst, and a water blowing agent. In a further variation, the cell opener is at about 1 parts by weight percent; the surfactant is at about 0.5 parts by weight percent; the cross-linking agent is at about 1.5 parts by weight percent; the catalyst includes a first catalyst at about 0.6 parts by weight percent and a second catalyst at about 0.3 parts by weight percent; and the water blowing agent is at about 3 parts by weight percent.

In a yet further variation, a vehicle component is formed of the polyurethane foam.

In a still further variation, the isocyanate is greater than or equal to about 33 parts by weight percent to less than or equal to about 40 parts by weight percent.

Further areas of applicability will become apparent from the description provided herein. It should be understood that the description and specific examples are intended for purposes of illustration only and are not intended to limit the scope of the present disclosure.

### DETAILED DESCRIPTION

The following description is merely exemplary in nature and is not intended to limit the present disclosure, application, or uses. It should be understood that throughout the drawings, corresponding reference numerals indicate like or corresponding parts and features.

As used herein, “isocyanates” include diisocyanates such as aromatic diisocyanates, toluene diisocyanates (“TDI”), and methylene diphenyl diisocyanates (“MDI”), as well as polyisocyanates, and mixtures thereof. Non-limiting examples of isocyanates include methylene diphenyl diisocyanate (MDI), toluene diisocyanate (TDI), hexamethylene diisocyanate (HDI), isophorone diisocyanate (IPDI), 4,4′-diisocyanatodicyclohexylmethane (H12MDI), 1,5-naphthalenediisocyanate (NDI), tetramethyllxylenediisocyanate (TMXDI), p-phenylenediisocyanate (PPDI), 1,4-cyclohexane diisocyanate (CDI), tolidine diisocyanate (TODI), and combinations thereof. It is contemplated isocyanates may include polymeric materials.

As used herein, “petrol-based polyols” are polyether polyols which can be used in the practice of the present disclosure and are well known and widely available commercially. Such polyols are generally at least about 80% by weight or more of a composition or blend of compositions directly or indirectly obtained from a non-renewable resource such as crude oil. In other embodiments, the polyols are generally at least about 85% by weight, at least 90% by weight, and/or at least 95% by weight or more of a composition or blend of compositions directly or indirectly obtained from a non-renewable resource such as crude oil. Non-limiting examples of the polyether polyols include polyoxyethylene glycol, polyoxypropylene glycol, polyoxybutylene glycol, polytetramethylene glycol, block copolymers, for example, combinations of polyoxypropylene and polyoxyethylene glycols, poly-1,2-oxybutylene and polyoxyethylene glycols, poly-1,4-tetramethylene and polyoxyethylene glycols, and random and block copolymer glycols prepared from blends or sequential addition of two or more alkylene oxides. The mechanical properties of the resultant polyurethane foam may dictate the consistency of the polyol. More specifically, higher molecular weight polyols generally form more flexible polyurethanes, whereas lower molecular weight polyols generally form more rigid polyurethanes.

As used herein, “bio-based polyols” refer to polyols generally at least about 80% by weigh or more of a composition or blend of compositions directly or indirectly obtained from a natural oil. In other embodiments, the polyols are generally at least about 85% by weight, at least 90% by weight, and/or at least 95% by weight or more of a composition or blend of compositions directly or indirectly obtained from a natural oil. Natural oil, as used herein, includes but is not limited to vegetable oils, animal fats, tall oils, derivatives of these oils, combinations of any of these oils, and the like. Representative non-limiting examples of vegetable oils include canola oil, rapeseed oil, coconut oil, corn oil, cottonseed oil, olive oil, palm oil, peanut oil, safflower oil, sesame oil, soybean oil, sunflower oil, linseed oil, palm kernel oil, tung oil, jatropha oil, mustard oil, pennycress oil, carnellina oil, and castor oil. Representative non-limiting examples of animal fats include lard, tallow, poultry fat, yellow grease, and fish oil, as well as polyols made from the bio-based diols 1,3-propanediol (PDO) and 1,4-butanediol (BDO) and diacids, including succinic acid and larger acids such as Elevance's Inherent C18 octadecanedioic acid (ODDA).

As used herein, “algae-based polyols” refer to polyols generally at least about 80% by weigh or more of a composition or blend of compositions directly or indirectly obtained from an algae oil. In other embodiments, the polyols are generally at least about 85% by weight, at least 90% by weight, and/or at least 95% by weight or more of a composition or blend of compositions directly or indirectly obtained from a algae oil. Algae oil, as used herein, includes but is not limited to microalgae, such as Nannochloropsis, Spirulina, Chlorella; algae, such as red algae-Rhodophyta, red algae, Pithophora oedegonia, green algae, among others, and combinations thereof.

As noted above, polyurethane foams are typically prepared by reacting isocyanates with polyols in the presence of additives. In such a manner, it is contemplated that a polyol solution according to the present disclosure includes at least a petrol-based polyol, a bio-based polyol, an algae-based polyol, and any desired additives. Such additives, some of which may be optional, include at least one of a cell opener, a surfactant, a cross-linking agent, a catalyst, and a water blowing agent. It is also contemplated that a polyol solution may include a petrol-based polyol, a bio-based polyol, cellulose reinforcements, and any desired additives.

Blowing agents assist in preparing foam, and water is a desirable blowing agent. Other blowing agents suitable according to the present disclosure include fluorocarbons, hydrochlorocarbons, chorofluorocarbons, hydrofluorocarbons, hydrocarbons. It is also contemplated that gas may be added directly to the polyol isocyanate reaction mixture to form the foam.

Surfactants are useful for cell nucleation and cell opening in foam applications and offer foam stabilization. One desirable surfactant is TEGOSTAB® B 4690, available from Evonik Degussa, but it is contemplated other nonionic surfactants may be suitable for preparing the polyurethane foams disclosed herein.

Cross-linking agents may be used to control flexural and other properties of the foam. Suitable cross-linking agents include diethanolamine (DEA) and triethanolamine, which, when used in foam applications, build firmness and increase catalytic activity.

Catalysts enhance the processing characteristics and physical properties of polyurethane foams by promoting the basic chemical reactions between polyol and isocyanate, reactions between water and isocyanate, and reactions to trimerizate isocyanates. Catalysts may be selected according to the needs of a particular application, for example, to improve the polyether foaming process of a wide variety of foams, including high-density unfilled foam, filled foam, high load-bearing flexible foam, low-density foam, and high resilience molded foam. Other catalysts may be selected to delay the foam-forming reaction process, which can result in more open foam structures. Suitable catalysts according to the present disclosure are diluted amine ethers, such as NIAX® A300 and liquid, water-soluble tertiary amines, such as NIAX® A-300, each of which are available from Momentive Performance Materials. Tertiary amines may be desirable as catalysts when water is present in the polyol isocyanate reaction mixture, as it catalyzes the isocyanate to react with water to form urea linkages with urethane. According to a form, the catalyst may comprise a first catalyst comprised of a diluted amine ether, and a second catalyst comprised of a water-soluble tertiary amine.

Cell openers may be used to prepare foam structures that have predominantly open cells, which gives it a larger value of air permeability and include water-soluble emulsifiers, such as LUMULSE® POE (26) GLYC, available from Vantage Specialty Chemicals, Inc.

Other optional additives include buffers, dendritic macromolecules, inorganic particulates, other types of polyols not listed herein, polyisocyanates, flame retardants, deodorants, colorants, fillers, combinations thereof, and other additives known to those familiar with the technology.

Algae-Based Polyurethane Foams

Various polyol-based foam compositions including petrol-based, soy-based, and algae-based foam compositions shown below in Table 1 were prepared and tested according to the teachings of the present disclosure.

TABLE 1
Example/Test Compositions of Petrol and Bio-Based
Polyurethane Foams in Parts by Weight Percent

| | | Agrol A 56 | Algae 150 | Rubinate |
|---|---|---|---|---|
| | Voranol | AO Soy | Algae | 7304 |
| Sample | 4701 | Polyol | Polyol | Isocyanate |
| 1 | 100.0 | 0.0 | 0.0 | 53.8 |
| 2 | 90.0 | 0.0 | 10.0 | 54.3 |
| 3 | 80.0 | 0.0 | 20.0 | 54.8 |
| 4 | 70.0 | 0.0 | 30.0 | 55.4 |
| 5 | 50.0 | 0.0 | 50.0 | 56.4 |
| 6 | 90.0 | 10.0 | 0.0 | 54.3 |
| 7 | 80.0 | 10.0 | 10.0 | 54.8 |
| 8 | 70.0 | 10.0 | 20.0 | 55.3 |
| 9 | 60.0 | 10.0 | 30.0 | 55.8 |
| 10 | 40.0 | 10.0 | 50.0 | 56.8 |
| 11 | 80.0 | 20.0 | 0.0 | 54.6 |
| 12 | 70.0 | 20.0 | 10.0 | 55.2 |
| 13 | 60.0 | 20.0 | 20.0 | 55.7 |
| 14 | 50.0 | 20.0 | 30.0 | 56.2 |
| 15 | 30.0 | 20.0 | 50.0 | 57.2 |
| 16 | 70.0 | 30.0 | 0.0 | 55.1 |
| 17 | 60.0 | 30.0 | 10.0 | 55.7 |
| 18 | 50.0 | 30.0 | 20.0 | 56.2 |
| 19 | 40.0 | 30.0 | 30.0 | 56.7 |
| 20 | 20.0 | 30.0 | 50.0 | 57.7 |
| 21 | 50.0 | 50.0 | 0.0 | 56.0 |
| 22 | 40.0 | 50.0 | 10.0 | 56.5 |
| 23 | 30.0 | 50.0 | 20.0 | 57.0 |
| 24 | 20.0 | 50.0 | 30.0 | 57.5 |

The working examples were produced according to the following procedure. First, a polyol mixture was formed by mixing together up to about 100 parts by weight percent petrol-polyol (e.g., VORANOL® 4701, available from Dow Chemical Co.), about 1 parts by weight percent cell opener (e.g., LUMULSE® POE (26) GLYC available from Lambent Corporation), about 0.5 parts by weight percent surfactant (e.g., TEGOSTAB® B4690, available from Evonik Nutrition & Care GmbH), about 1.5 parts by weight percent cross-linking agent (e.g., DEA), about 0.3 parts by weight percent of a first catalyst (e.g., NIAX® A1, available from Momentive Performance Materials) and about 0.6 parts by weight of a second catalyst (e.g., NIAX® A300, also available from Momentive Performance Materials), about 3 parts by weight percent blowing agent (e.g., deionized water), and, optionally, up to about 50 parts by weight percent soy-based polyol (e.g., AGROL® A 56 AO, available from BioBased Chemicals, LLC), and, optionally, up to about 50 parts by weight percent algae-based polyol (e.g., Algae 150 algae polyol, available from Algenesis Materials) were added with a handheld mixer at 1500 rpm for a five minutes. An isocyanate (e.g., RUBINATE® 7304, available from Huntsman International LLC) was added to the polyol mixture and mixed with the mixer for 12 seconds. The reaction mixture was poured into a closed mold system that had been coated with Chem-Trend PU-11331 release agent and warmed in a pre-heated oven at 65° C. for 15 minutes. Each foam was able to rise within the mold and demolding time was 6 minutes and upon release from the mold, was crushed by hand to release trapped gases. Each foam was placed in a pre-heated oven at 65° C. for 30 minutes and subsequently removed from the oven and then at room temperature for a minimum of 12 hours to allow for proper curing.

The resultant foams of the working examples shown in Table 1 had their apparent density tested according to ASTM 3574-08, Test A; their compression force deflection tested according to ASTM 3574-08, Test C; their wet compression tested according to ASTM 3574-08, Test L; their tensile strength at break tested according to ASTM 3574-08, Test E; their elongation at max load tested according to ASTM 3574-08, Test E; and their test strength tested according to ASTM D 624, Die C. SAG factor values of the foams were also calculated from compression stress values. Three samples were measured for each test and the results were averaged. Table 2 below shows the results of the respective tests. (Parentheticals represent standard deviation).

TABLE 2
Mechanical Properties of Compositions Formed According to Table 1

| | | | Wet | | | | | | | | | |
|---|---|---|---|---|---|---|---|---|---|---|---|---|
| | | | Compression | | | | Maximum Tensile | | Elongation | | | |
| | Density | | Set | | Compression Modulus | | Strength | | at maximum load | | Young's Modulus | |
| Sample | (kg/m³) | | (% Compression) | | (MPa) | | (kPa) | | (mm) | | (kPa) | |
| 1 | 47.2 | (0.9) | 21.1 | (3.2) | 0.056 | (0.004) | 114.6 | (10.1) | 88.4 | (8.5) | 194.0 | (12.9) |
| 2 | 48.5 | (1.0) | 32.5 | (4.0) | 0.056 | (0.004) | 128.8 | (5.6) | 100.8 | (3.2) | 182.2 | (12.0) |
| 3 | 47.7 | (0.9) | 35.8 | (2.3) | 0.084 | (0.004) | 139.4 | (7.4) | 100.7 | (3.6) | 209.1 | (5.4) |
| 4 | 47.7 | (0.8) | 38.6 | (1.4) | 0.085 | (0.004) | 142.0 | (7.5) | 89.6 | (4.1) | 237.8 | (21.5) |
| 5 | 48.0 | (0.3) | 46.3 | (1.1) | 0.160 | (0.014) | 145.9 | (7.9) | 78.6 | (4.7) | 499.7 | (49.5) |
| 6 | 47.6 | (0.3) | 27.6 | (2.5) | 0.069 | (0.003) | 107.0 | (6.8) | 94.2 | (4.2) | 170.7 | (13.7) |
| 7 | 50.4 | (1.3) | 33.7 | (1.1) | 0.071 | (0.005) | 137.0 | (8.0) | 101.4 | (7.7) | 211.1 | (18.9) |
| 8 | 49.8 | (1.0) | 38.1 | (1.0) | 0.090 | (0.004) | 151.7 | (10.4) | 102.9 | (6.7) | 248.5 | (20.6) |
| 9 | 48.7 | (2.6) | 41.4 | (1.7) | 0.103 | (0.007) | 128.0 | (9.7) | 88.2 | (6.9) | 251.6 | (20.6) |
| 10 | 52.5 | (1.5) | 44.6 | (1.2) | 0.199 | (0.009) | 142.6 | (7.1) | 77.0 | (4.0) | 372.8 | (32.3) |
| 11 | 50.3 | (1.4) | 29.8 | (1.9) | 0.084 | (0.008) | 140.1 | (14.4) | 100.4 | (6.4) | 208.6 | (19.0) |
| 12 | 51.3 | (1.0) | 34.6 | (1.7) | 0.074 | (0.005) | 145.9 | (12.2) | 97.2 | (7.1) | 255.2 | (20.1) |
| 13 | 48.4 | (1.3) | 40.1 | (1.7) | 0.107 | (0.009) | 126.9 | (6.5) | 88.8 | (4.9) | 260.5 | (15.5) |
| 14 | 48.9 | (0.6) | 42.3 | (1.0) | 0.121 | (0.005) | 142.6 | (6.3) | 84.7 | (1.4) | 335.2 | (32.3) |
| 15 | 47.6 | (0.7) | 47.3 | (1.1) | 0.162 | (0.008) | 134.7 | (2.8) | 63.9 | (1.9) | 442.8 | (18.3) |
| 16 | 43.8 | (1.8) | 41.7 | (1.3) | 0.074 | (0.005) | 109.8 | (8.4) | 88.6 | (6.5) | 184.4 | (12.0) |
| 17 | 43.5 | (0.6) | 46.0 | (1.0) | 0.096 | (0.002) | 126.9 | (2.7) | 91.7 | (3.5) | 218.8 | (15.7) |
| 18 | 44.3 | 1.2) | 48.6 | (0.3) | 0.126 | (0.009) | 105.0 | (11.9) | 77.2 | (6.9) | 239.4 | (15.1) |
| 19 | 44.0 | (0.7) | 50.4 | (1.2) | 0.143 | (0.008) | 121.1 | (5.1) | 70.2 | (2.2) | 324.2 | (8.7) |
| 20 | 49.5 | (0.9) | 46.1 | (1.0) | 0.177 | (0.009) | 92.8 | (4.7) | 42.2 | (3.6) | 429.7 | (37.0) |
| 21 | 49.4 | (0.6) | 36.0 | (1.9) | 0.096 | (0.007) | 110.1 | (6.8) | 78.4 | (4.6) | 246.5 | (21.1) |
| 22 | 46.9 | (2.2) | 39.5 | (2.3) | 0.107 | (0.007) | 116.1 | (8.4) | 66.7 | (4.2) | 339.9 | (28.3) |
| 23 | 47.1 | (3.0) | 43.1 | (1.3) | 0.117 | (0.009) | 106.1 | (8.8) | 61.5 | (4.5) | 353.2 | (28.9) |
| 24 | 51.6 | (1.1) | 45.3 | (0.8) | 0.157 | (0.008) | 98.6 | (7.9) | 47.8 | (2.7) | 372.1 | (32.1) |

| | Compression | | Compression | | Compression | | | | | | | |
|---|---|---|---|---|---|---|---|---|---|---|---|---|
| | Stress at 25% Strain | | Stress at 50% Strain | | Stress at 65% Strain | | SAG Factor | | SAG Factor | | Tear Resistance | |
| Sample | (MPa) | | (MPa) | | (MPa) | | 65%/25% | | 50%/25% | | (N/m) | |
| 1 | 0.0049 | (0.0002) | 0.0074 | (0.0002) | 0.0122 | (0.0004) | 2.50 | (0.10) | 1.52 | (0.02) | 475.1 | (34.4) |
| 2 | 0.0050 | (0.0003) | 0.0076 | (0.0003) | 0.0124 | (0.0004) | 2.50 | (0.14) | 1.53 | (0.04) | 539.7 | (36.9) |
| 3 | 0.0074 | (0.0006) | 0.0110 | (0.0007) | 0.0182 | (0.0010) | 2.47 | (0.10) | 1.50 | (0.03) | 565.4 | (31.2) |
| 4 | 0.0089 | (0.0004) | 0.0125 | (0.0006) | 0.0196 | (0.0010) | 2.19 | (0.04) | 1.39 | (0.02) | 575.5 | (10.5) |
| 5 | 0.0193 | (0.0012) | 0.0255 | (0.0013) | 0.0390 | (0.0017) | 2.03 | (0.12) | 1.32 | (0.04) | 640.9 | (27.9) |
| 6 | 0.0057 | (0.0005) | 0.0088 | (0.0007) | 0.0147 | (0.0008) | 2.60 | (0.11) | 1.54 | (0.02) | 406.1 | (37.1) |
| 7 | 0.0063 | (0.0005) | 0.0092 | (0.0006) | 0.0152 | (0.0009) | 2.43 | (0.10) | 1.47 | (0.03) | 448.8 | (30.9) |
| 8 | 0.0080 | (0.0003) | 0.0119 | (0.0003) | 0.0194 | (0.0006) | 2.42 | (0.09) | 1.48 | (0.03) | 543.6 | (21.4) |
| 9 | 0.0096 | (0.0002) | 0.0139 | (0.0005) | 0.0226 | (0.0011) | 2.36 | (0.09) | 1.45 | (0.03) | 554.7 | (23.2) |
| 10 | 0.0186 | (0.0006) | 0.0263 | (0.0006) | 0.0430 | (0.0011) | 2.31 | (0.07) | 1.41 | (0.03) | 601.5 | (11.2) |
| 11 | 0.0082 | (0.0006) | 0.0125 | (0.0006) | 0.0120 | (0.0009) | 2.44 | (0.15) | 1.53 | (0.06) | 533.7 | (18.3) |
| 12 | 0.0071 | (0.0004) | 0.0105 | (0.0005) | 0.0169 | (0.0008) | 2.37 | (0.10) | 1.47 | (0.03) | 492.3 | (45.1) |
| 13 | 0.0106 | (0.0005) | 0.0153 | (0.0008) | 0.0245 | (0.0014) | 2.32 | (0.06) | 1.45 | (0.03) | 551.0 | (26.0) |
| 14 | 0.0104 | (0.0003) | 0.0153 | (0.0003) | 0.0254 | (0.0006) | 2.45 | (0.07) | 1.47 | (0.03) | 520.3 | (27.1) |
| 15 | 0.0221 | (0.0009) | 0.0283 | (0.0008) | 0.0420 | (0.0012) | 1.90 | (0.08) | 1.28 | (0.03) | 503.5 | (18.7) |
| 16 | 0.0067 | (0.0003) | 0.0099 | (0.0006) | 0.0163 | (0.0010) | 2.44 | (0.09) | 1.49 | (0.03) | 430.3 | (35.4) |
| 17 | 0.0081 | (0.0004) | 0.0122 | (0.0006) | 0.0204 | (0.0006) | 2.52 | (0.07) | 1.52 | (0.02) | 472.7 | (29.0) |
| 18 | 0.0105 | (0.0007) | 0.0158 | (0.0011) | 0.0264 | (0.0019) | 2.51 | (0.06) | 1.50 | (0.02) | 478.7 | (18.7) |
| 19 | 0.0134 | (0.0008) | 0.0190 | (0.0010) | 0.0310 | (0.0014) | 2.31 | (0.09) | 1.41 | (0.03) | 598.4 | (20.7) |
| 20 | 0.0233 | (0.0004) | 0.0304 | (0.0010) | 0.0451 | (0.0015) | 1.93 | (0.06) | 1.31 | (0.03) | 433.2 | (33.7) |
| 21 | 0.0087 | (0.0005) | 0.0131 | (0.0006) | 0.0213 | (0.0011) | 2.45 | (0.08) | 1.51 | (0.04) | 454.6 | (39.3) |
| 22 | 0.0098 | (0.0003) | 0.0143 | (0.0004) | 0.0233 | (0.0008) | 2.39 | (0.08) | 1.46 | (0.02) | 545.7 | (20.8) |
| 23 | 0.0117 | (0.0003) | 0.0164 | (0.0005) | 0.0263 | (0.0009) | 2.25 | (0.08) | 1.41 | (0.02) | 463.2 | (20.3) |
| 24 | 0.0185 | (0.0015) | 0.0254 | (0.0011) | 0.0384 | (0.0016) | 2.09 | (0.09) | 1.38 | (0.06) | 431.4 | (29.6) |

The results and data presented in Table 2 demonstrate that polyurethane foam produced from petrol-based polyol compositions including algae-based polyols offset mechanical deficiencies expected from petrol-based polyol compositions including soy-based polyols. More specifically, as shown in Table 2, small amounts of algae content (e.g., below about 20 parts by weight percent) resulted in polyurethane foams having increased wet compression set, compression strength, compression stress at 25, 50, and 65% strain, Young's modulus, and tear resistance.

The polyurethane foams disclosed hereunder may be used in various applications where it is desirable to have foams having the properties disclosed hereunder. Further, the polyurethane foams disclosed hereunder may be used in various automotive applications and for vehicle components, including but not limited to seat backs, seat cushions, headrests, armrests, headliners, engine covers, and instrument panels.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

Although the terms first, second, third, etc. may be used to describe various elements, components, regions, layers and/or sections, these elements, components, regions, layers and/or sections, should not be limited by these terms. These terms may be only used to distinguish one element, component, region, layer and/or section, from another element, component, region, layer and/or section. Terms such as “first,” “second,” and other numerical terms when used herein do not imply a sequence or order unless clearly indicated by the context. Thus, a first element, component, region, layer or section, could be termed a second element, component, region, layer or section without departing from the teachings of the example forms. Furthermore, an element, component, region, layer or section may be termed a “second” element, component, region, layer or section, without the need for an element, component, region, layer or section termed a “first” element, component, region, layer or section.

Spacially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above or below. The device may be otherwise oriented (rotated 90 degrees or at other orientations) and the spatially relative descriptors used herein interpreted accordingly.

As used herein, the phrase at least one of A, B, and C should be construed to mean a logical (A OR B OR C), using a non-exclusive logical OR, and should not be construed to mean “at least one of A, at least one of B, and at least one of C.”

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A polyurethane foam produced by reacting a polyol-containing composition and an isocyanate composition, wherein the polyol-containing composition comprises:
an algae-based polyol at less than or equal to about 20 parts by weight percent;
a petrol-based polyol at greater than or equal to about 70 parts by weight percent to less than or equal to about 90 parts by weight percent; and
a balance of a soy-based polyol.

2. The polyurethane foam of claim 1, wherein the polyurethane foam further comprises at least one of a cell opener, a surfactant, a cross-linking agent, a catalyst, and a water blowing agent.

3. The polyurethane foam of claim 1 further comprising:
a cell opener at about 1 parts by weight percent;
a surfactant at about 0.5 parts by weight percent;
a cross-linking agent is at about 1.5 parts by weight percent;
a catalyst comprising a first catalyst at about 0.6 parts by weight percent and a second catalyst at about 0.3 parts by weight percent; and
a water blowing agent at about 3 parts by weight percent.

4. The polyurethane foam of claim 1, wherein the polyurethane foam has a compression set of less than or equal to about 50%.

5. The polyurethane foam of claim 1, wherein the polyurethane foam has a tensile strength of greater than or equal to about 100 kPa.

6. The polyurethane foam of claim 1, wherein the polyurethane foam has a tear resistance of greater than or equal to about 450 N/m.

7. A vehicle component comprising the polyurethane foam of claim 1.

8. A polyurethane foam produced by reacting a polyol-containing composition and an isocyanate composition, wherein the polyol-containing composition comprises:
a soy-based polyol at less than or equal to about 20 parts by weight percent;
a petrol-based polyol at greater than or equal to about 70 parts by weight percent to less than or equal to about 90 parts by weight percent; and
a balance of an algae-based polyol.

9. The polyurethane foam of claim 8, wherein the polyurethane foam further comprises at least one of a cell opener, a surfactant, a cross-linking agent, a catalyst, and a water blowing agent.

10. The polyurethane foam of claim 8 further comprising:
a cell opener at about 1 parts by weight percent;
a surfactant s at about 0.5 parts by weight percent;
a cross-linking agent is at about 1.5 parts by weight percent;
a catalyst comprising a first catalyst at about 0.6 parts by weight percent and a second catalyst at about 0.3 parts by weight percent; and
a water blowing agent at about 3 parts by weight percent.

11. The polyurethane foam of claim 8, wherein the polyurethane foam has a compression set of less than or equal to about 50%.

12. The polyurethane foam of claim 8, wherein the polyurethane foam has a tensile strength of greater than or equal to about 100 kPa.

13. The polyurethane foam of claim 8, wherein the polyurethane foam has a tear resistance of greater than or equal to about 450 N/m.

14. A vehicle component comprising the polyurethane foam of claim 8.

15. A polyurethane foam produced by reacting a polyol-containing composition and an isocyanate composition, wherein the polyol-containing composition comprises:
a bio-based polyol consisting essentially of a combination of a soy-based polyol and an algae-based polyol at less than or equal to about 80 parts by weight percent; and
a balance of a petrol-based polyol.

16. The polyurethane foam of claim 15, wherein the bio-based polyol is less than or equal to about 80 parts by weight percent.

17. The polyurethane foam of claim 15, wherein the polyurethane foam further comprises at least one of a cell opener, a surfactant, a cross-linking agent, a catalyst, and a water blowing agent.

18. The polyurethane foam of claim 15 further comprising:
a cell opener at about 1 parts by weight percent;
a surfactant s at about 0.5 parts by weight percent;
a cross-linking agent is at about 1.5 parts by weight percent;
a catalyst comprising a first catalyst at about 0.6 parts by weight percent and a second catalyst at about 0.3 parts by weight percent; and
a water blowing agent at about 3 parts by weight percent.

19. A vehicle component comprising the polyurethane foam of claim 15.

20. The polyurethane foam of claim 15, wherein the isocyanate composition is greater than or equal to about 33 parts by weight percent to less than or equal to about 40 parts by weight percent.
